(19) United States
(12) Patent Application Publication
(10) Pub. No.: US 2011/0049984 A1
(43) Pub. Date: Mar. 3, 2011

(54) POWER-CONSUMPTION CONTROL APPARATUS AND METHOD FOR SMART METER

(75) Inventor: Myung-Hee SON, Daejeon (KR)

(73) Assignee: ELECTRONICS AND TELECOMMUNICATIONS RESEARCH INSTITUTE, Daejeon-city (KR)

(21) Appl. No.: 12/858,787

(22) Filed: Aug. 18, 2010

(30) Foreign Application Priority Data
Aug. 27, 2009 (KR) 10-2009-0079739
Feb. 19, 2010 (KR) 10-2010-0015271

(51) Int. Cl. H02J 3/14

(52) U.S. Cl. 307/31

(57) ABSTRACT

The present invention relates to a power-consumption control apparatus and method for a smart meter. The total amount of power consumption and amounts of power consumption of individual electrical devices connected are sensed, and the amounts of power consumption of the individual electrical devices are analyzed. The total amount of power consumption of the electrical devices is compared with a preset progressive amount on the basis of the analyzed result and supply and shutoff of power to the electrical devices is controlled on the comparison result. According to embodiments of the present invention, power consumption (power shutoff and supply) in homes, factories, and offices is automatically and effectively managed and controlled, which makes it possible for consumers to pay lower electrical bill and for power suppliers to improve the efficiency of power distribution by efficiently estimating power consumption.

### BACKGROUND OF THE INVENTION

1. Field of the Invention

The present invention relates to a power-consumption control apparatus and method for a smart meter, and in particular, a power-consumption control apparatus and method for a smart meter which is capable of shutting off electrical devices on the basis of amounts of power consumption as well as showing monitored results of amounts of power consumption at homes, factories, shopping centers, offices, etc., in a smart grid to consumers in real time

2. Description of the Related Art

There are a lot of electrical devices in homes, factories, shopping centers, and offices consuming electric power. If power is inefficiently used, energy is wasted due to inefficient generation of power, causing greenhouse gas emission, which is the biggest cause of global warming increases. Moreover, electrical bill considerably increases for consumers requiring power, which becomes a financial burden.

Recently, all electrical devices used in a home are connected to a smart meter through Ring or LAN.

However, currently released smart meters just show the amounts of power consumption and bill information to consumers.

In this case, consumers should save power themselves due to the limitations of a smart grid policy for energy conservation and efficient distribution of energy. That is, existing smart meters having a simple monitoring function are unable to actively control an electric power network.

### SUMMARY OF THE INVENTION

In order to solve the above-mentioned problem, it is an object of the present invention to provide a power-consumption control apparatus and method for a smart meter which is capable of automatically controlling shutoff and supply of power to electrical devices on the basis of amounts of power consumption as well as giving priorities to the electrical devices and setting the electrical devices in a standard mode.

According to an aspect of the present invention, it is provided a power-consumption control apparatus for a smart meter including: a communicating unit connected to electrical devices; a power sensing unit configured to sense an amount of power consumption of each of the electrical devices; an analyzing unit configured to analyze the sensed amount of power consumption of each of the electrical devices in real time and compute power use pattern; and a power control unit configured to compare a total amount of power consumption of the electrical devices with a preset progressive amount on the basis of the analyzed result of the analyzing unit, and control supply and shutoff of power to the electrical devices on the basis of the comparison result.

The analyzing unit may give a power use priority to each of the electrical devices on the basis of the power use pattern.

When the total amount of power consumption of the electrical devices is equal to or greater than the progressive amount, the power control unit may check the power use priority of each of the electrical devices and shut off power to the electrical devices in ascending order of the power use priority.

When the total amount of power consumption of the electrical devices is equal to or greater than the progressive amount, the power control unit may shut off power to an electrical device predetermined or selected by a user.

The power control unit may increase the number of electrical devices shut off until the total amount of power consumption of the electrical devices is less than a target value.

When the total amount of power consumption of the electrical devices is less than the progressive amount, the power control unit may perform control such that power to at least one electrical device is shut off according to a user set value regarding the operation of the electrical devices.

When the total amount of power consumption of the electrical devices is less than a target value, the power control unit may perform control such that power to electrical devices having been shut off is resupplied in descending order of the power use priority.

When the total amount of power consumption of the electrical devices is less than a target value, the power control unit may perform control such that power is resupplied to an electrical device predetermined or selected by a user among electrical devices having been shut off.

The power control unit may control ON/OFF operations of a switch, which is disposed on a power supply line connected to the at least electrical device and control power supply to the electrical devices, so as to supply or shut off power to the electrical devices.

The power control unit may transmit a control message including a power supply or shutoff command to a corresponding electrical device such that power to the corresponding electrical device is supplied or shut off.

The power-consumption control apparatus may further include a storage unit configured to store environment information of the electrical devices connected to the communicating unit.

The environment information of the electrical devices may include at least one of information on the relationship between the amount of power consumption of the electrical devices and date/time, information on the relationship between power consumption and inside/outside temperatures, information on the operational features of the electrical devices, and information on a power use pattern of members in the home, and set information of a corresponding electrical device.

The communicating unit may be connected to the electrical devices through Ring or LAN.

According to another aspect of the present invention, it is provided a power-consumption control method for a smart meter including: receiving environment information connected electrical devices; sensing an amount of power consumption of each of the electrical devices; analyzing the amount of power consumption of each of the electrical devices on the basis of the environment information of the electrical devices in real time, and computing a power use pattern of the electrical devices; and comparing a total amount of power consumption of the electrical devices with a preset progressive amount and controlling supply and shutoff of power to the electrical devices on the basis of the comparison result.

The analyzing of the amount of power consumption may include giving a power use priority to each of the electrical devices on the basis of the power use pattern.

When the a total amount of power consumption of the electrical devices is equal to or greater than the progressive amount, the controlling of supply and shutoff of power may include checking the power use priority of each of the electrical devices and shutting off power to the electrical devices in ascending order of the power use priority.

When the a total amount of power consumption of the electrical devices is equal to or greater than the progressive amount, the controlling of supply and shutoff of power may include performing control such that power to an electrical device predetermined or selected by a user is shut off.

The controlling of supply and shutoff of power may increase the number of electrical devices shut off until the total amount of power consumption of the electrical device is less than a target value.

When the total amount of power consumption of the electrical devices is less than the progressive amount, the controlling of supply and shutoff of power may include performing control such that power to at least one electrical device is shut off according to a user set value regarding the operation of the electrical devices.

The environment information of the electrical devices may include at least one of information on the relationship between the amount of power consumption of the electrical devices and date/time, information on the relationship between power consumption and inside/outside temperatures, information on the operational features of the electrical devices, and information on a power use pattern of members in the home, and set information of a corresponding electrical device.

According to embodiments of the present invention, power consumption (power shutoff and supply) in homes, factories, and offices is automatically and effectively managed and controlled, which makes it possible for consumers to pay lower electrical bills and for power suppliers to improve the efficiency of power distribution by efficiently estimating power consumption. That is, it is possible to efficiently control supply and consumption of power by giving ratings to electrical devices.

### BRIEF DESCRIPTION OF THE DRAWINGS

FIG. 1 is a view illustrating a configuration of a system adapting a power-consumption control apparatus for a smart meter according to an embodiment of the present invention;

FIG. 2 is a block diagram illustrating a configuration of a power-consumption control apparatus for a smart meter according to an embodiment of the present invention; and

FIG. 3 is a flowchart illustrating the operational steps of a power-consumption control method for a smart meter according to an embodiment of the present invention.

### DETAILED DESCRIPTION OF THE PREFERRED EMBODIMENTS

Embodiments of the present invention will be described hereinafter with reference to the accompanying drawings.

A power-consumption control apparatus (hereinafter, referred to as a smart keeper) for a smart meter according to an embodiment of the present invention is applicable to any places where electrical devices 200 are installed inside and thus power is consumed, such as homes, factories, shopping centers, offices, etc.

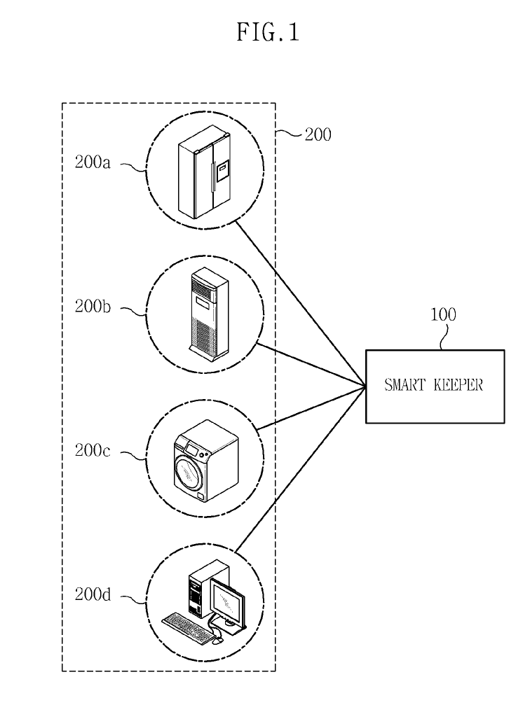

FIG. 1 is a view illustrating a configuration of a system adapting a power-consumption control apparatus for a smart meter according to an embodiment of the present invention.

The embodiment of FIG. 1 will be described on the assumption that home devices are installed at home. As shown in FIG. 1, electrical devices 200 such as a refrigerator 200a, an air conditioner 200b, a washing machine 200c, and a computer 200d are connected to a smart keeper 100 for controlling power supply to the home. In this case, each of the electrical devices 200 is wirelessly connected to the smart keeper 100 through Ring or LAN.

The smart keeper 100 monitors an amount of power consumption of each electrical device 200 and controls supply and shutoff of power to each electrical device 200.

As an example, the smart keeper 100 automatically shuts off power to the washing machine 200c or an unused PC during the daytime in the middle of summer so as to prevent the total amount of power consumption from exceeding an estimated amount of power consumption by a power supplier.

Therefore, if the smart keeper 100 according to the embodiment of the present invention is used, unnecessary power generation is avoided and a problem due to an increase in power consumption is prevented.

Here, in order to realize the operation of supplying and shutting off power to each electrical device 200, the smart keeper 100 may control ON/OFF operation of a separately disposed switch to shut off power to an unused electrical device 200 in the home and resupply power to the electrical device 200.

Meanwhile, when the individual electrical devices 200 are connected to one another through Ring or LAN, not in a P2P scheme, the smart keeper 100 may transmit a control message for supply and shutoff of power to each electrical device 200 to shut off or resupply power to each electrical device 200.

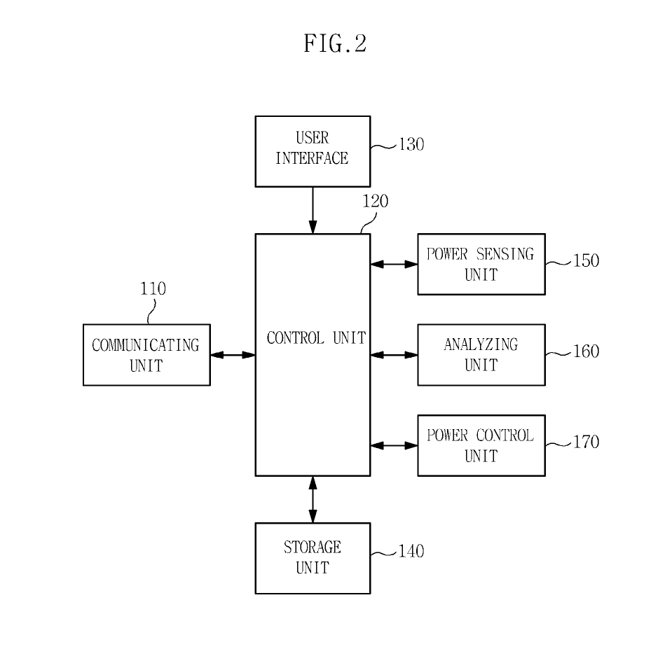

A power-consumption control apparatus for a smart meter according to an embodiment of the present invention will now be described in detail with reference to FIG. 2.

FIG. 2 is a block diagram illustrating a configuration of a power-consumption control apparatus for a smart meter according to an embodiment of the present invention.

As shown in FIG. 2, a power-consumption control apparatus includes a communicating unit 110, a control unit 120, a user interface 130, a storage unit 140, a power sensing unit 150, an analyzing unit 160, and a power control unit 170.

The communicating unit 110 is connected to the individual electrical devices 200 installed in the home through Ring or LAN. When being connected to the individual electrical devices 200, the communicating unit 110 receives environment information from the individual electrical devices 200 and transmits the environment information to the control unit 120.

The control unit 120 controls the operations of the individual units of the smart keeper 100. If receiving the environment information of the individual electrical devices 200 from the communicating unit 110 connected to the individual electrical devices 200, the control unit 120 stores the environment information in the storage unit 140.

Here, the environment information of each of the electrical devices 200 includes of information on the relationship between an amount of power consumption of the corresponding electrical device 200 and date/time, information on the relationship between power consumption and inside/outside temperatures, information on the operational features of the corresponding electrical device 200, and information on the power use pattern of members in the home.

The environment information may further include set information that a user inputs the corresponding electrical device 200.

The power sensing unit 150 senses the amounts of power consumption of the connected individual electrical devices 200.

The analyzing unit 160 analyzes the amounts of power consumption sensed by the power sensing unit 150. Moreover, the analyzing unit 160 analyzes power use pattern on the basis of an amount of real-time power consumption of the corresponding electrical device 200.

Then, the analyzing unit 160 sets power use priorities to the individual electrical devices 200 on the basis of the power use patterns of the individual electrical devices 200. Understandably, when a user sets priorities to the individual electrical devices 200 in advance, the analyzing unit 160 may not set the power use priorities.

The power control unit 170 sets a power use mode in the home on the basis of the analyzed result of the analyzing unit 160. At this time, the power control unit 170 compares the total amount of power consumption of the individual electrical devices 200 with a preset progressive amount, and controls supply and shutoff of power to each of the electrical devices 200 on the basis of the comparison result.

At this time, the power control unit 170 may compare the amount of power consumption of each of the electrical devices 200 with the preset progressive amount set of the corresponding electrical device 200 or compare the total amount of power consumption of the electrical devices 200 with a preset progressive amount of the whole electrical devices 200.

As an example, if the total amount of power consumption of the electrical devices 200 is equal to or greater than the preset progressive amount of all the electrical devices 200, the power control unit 170 checks the power use priorities of the electrical devices 200 and shuts off power to the electrical devices 200 in ascending order of the power use priorities.

As another example, if the total amount of power consumption of the electrical devices 200 is equal to or greater than the preset progressive amount of all the electrical devices 200, the power control unit 170 shuts off power to the electrical devices 200 predetermined or selected by a user.

Understandably, the power control unit 170 shuts off power to electrical device 200 until the total amount of power consumption is less than a target value.

For example, in the embodiment of FIG. 1 in which the refrigerator 200a, the air conditioner 200b, the washing machine 200c, and the computer 200d are installed, since the refrigerator 200a is an electrical device 200 that should always receive power supply, a high power use priority is set to the refrigerator 200a. The frequency of use of the air conditioner 200b is high in the middle of summer and is low in the middle of winter. Therefore, a high power use priority is set to the air conditioner 200b in the middle of summer and a low power use priority is set to the air conditioner 200b in the middle of winter.

Meanwhile, the power use priority for the washing machine 200c or the computer 200d may become high or low in specific time slots according to the operational features of the corresponding electrical device 200 by a user.

That is, in the middle of winter, if the total amount of power consumption of the electrical devices 200 is equal to or greater than the preset progressive amount, the power control unit 170 shuts off power to the air conditioner 200b having a relatively low power use priority.

Understandably, if the total amount of power consumption of the electrical devices 200 is equal to or greater than the preset progressive amount even after power to the air conditioner 200b is shut off, the power control unit 170 shuts off power to the washing machine 200c having a relatively low power use priority of the electrical devices 200 except for the air conditioner 200b.

The power supply and shutoff operations of the power control unit 170 may be realized in various ways.

As an example, the power control unit 170 may control ON/OFF operations of a switch, which is separately disposed on a power supply line connected to each of the electrical devices 200, to supply and shut off power to the corresponding electrical device 200.

Here, a plurality of switches may be disposed corresponding to the individual electrical devices 200 or one multi-switch may be connected to power supply lines to the electrical devices 200.

As another example, in order to shut off power to an electrical device 200 having a low priority, the power control unit 170 may transmit a control message to the corresponding electrical device 200 through the communicating unit 110 such that the corresponding electrical device 200 performs power shutoff itself.

In this case, in order to resupply power to the corresponding electrical device 200, the power control unit 170 may transmit a control message to the corresponding electrical device 200 through the communicating unit 110 such that the corresponding electrical device 200 releases the power shutoff itself.

The operation of the embodiment of the present invention having the above-mentioned configuration will be described below.

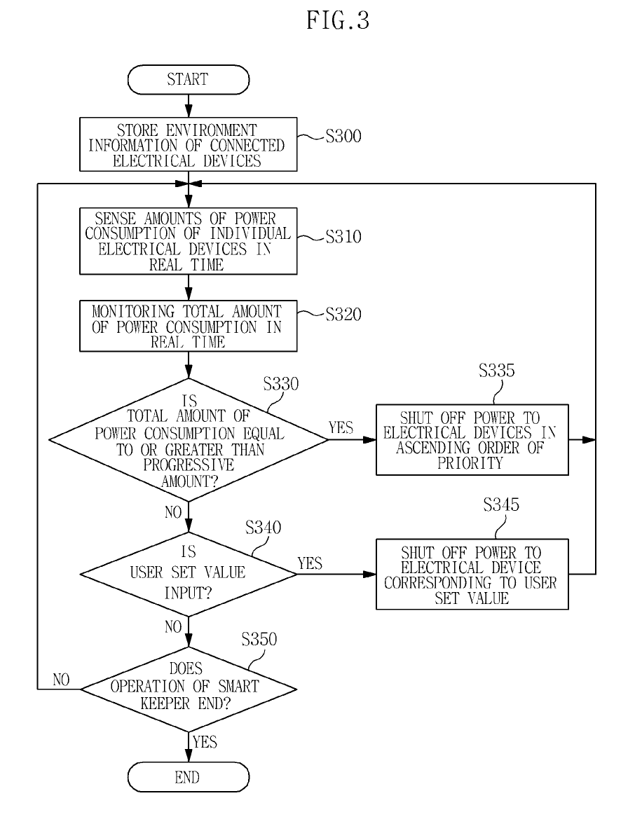

FIG. 3 is a flowchart illustrating the operational steps of a power-consumption control method for a smart meter according to an embodiment of the present invention.

As shown in FIG. 3, the smart keeper 100 receives the environment information from each of the electrical devices 200 connected thereto and stores the environment information (S300).

Here, environment information of each of the electrical devices 200 includes at least one of information on the relationship between an amount of power consumption of the corresponding electrical device 200 and date/time, information on the relationship between power consumption and inside/outside temperatures, information on the operational features of the corresponding electrical device 200, and information on the power use pattern of members in the home. Environment information may further include set information that a user inputs to the corresponding electrical device 200.

Next, the smart keeper 100 senses the amounts of power consumption of the individual electrical devices 200 in real time (S310).

The smart keeper 100 analyzes the amounts of power consumption of the individual electrical devices 200 sensed in real time in step S310 on the basis of the environment information stored in step S300, and monitors the analyzed result (S320).

Then, the smart keeper 100 checks whether the total amount of power consumption of the individual electrical devices 200, which is the analyzed result obtained in step S320, is equal to or greater than the preset progressive amount (S330).

If the total amount of power consumption of the individual electrical devices 200 is equal to or greater than the preset progressive amount, the smart keeper 100 checks the power use priorities of the individual electrical devices 200 and shuts off power to an electrical device 200 having the lowest power use priority (S335).

Next, the smart keeper 100 reperforms step S310, in which it monitors the total amount of power consumption of the individual electrical devices 200 in real time. If the total amount of power consumption of the individual electrical devices 200 is equal to or greater than the preset progressive amount even after the electrical device 200 having the lowest power use priority has been shut off, the smart keeper 100 repeatedly performs steps S310 to S335 until the total amount of power consumption of the individual electrical devices 200 is less than the target value.

In the above-mentioned example, step S335 is configured to shut off power to an electrical device 200 having the lowest power use priority. However, step S335 is configured to shut off power to an electrical device 200 predetermined or selected by a user.

Meanwhile, if it is determined in step S330 that the total amount of power consumption of the individual electrical devices 200 is less than the preset progressive amount, in general, it is preferable to monitor the amounts of power consumption of the individual electrical devices 200 in real time until the operation of the smart keeper 100 ends. However, if a user set value for the operation of an electrical device 200 is input (S340), the smart keeper 100 shuts off power to an electrical device 200 corresponding to the input user set value (S345).

For example, when a user inputs a user set value such that power to the air conditioner 200b is shut off during a specific time slot, power to the air conditioner 200b may be shut off during the specific time slot according to the user set value.

The operations of supplying and shutting off power to the individual electrical devices 200 may be realized by ON/OFF operations of switches separately disposed in the smart keeper 100, and the smart keeper 100 may transmit a control message to an electrical device 200 such that the corresponding electrical device 200 shuts off power thereto for itself.

Steps S310 to S345 are repeatedly performed, and the operation of the smart keeper 100 ends if an operation end command is input to the smart keeper 100 (S350).

Although FIG. 3 shows the operational flow of shutting off power to the individual electrical devices 200, the operation of resupplying power to electrical devices 200 having been shut off is similar to that shown in FIG. 3.

That is, if the total amount of power consumption of the individual electrical devices 200 is less than a target value, the smart keeper 100 may resupply power to the electrical devices 200 in descending order of power use priorities, or resupply power to the electrical devices 200 according to user set values.

Although the power-consumption control apparatuses and method for a smart meter according to the embodiments of the present invention have been described above with reference to the accompanying drawings, they are used in a generic and descriptive sense only and not for purposes of limitation. It will be apparent to those skilled in the art that modifications and variations can be made in the present invention without deviating from the spirit or scope of the invention.

What is claimed is:

1. A power-consumption control apparatus for a smart meter comprising:
a communicating unit connected to electrical devices;
a power sensing unit configured to sense an amount of power consumption of each of the electrical devices;
an analyzing unit configured to analyze the amount of power consumption of each of the electrical devices in real time, and compute a power use pattern; and
a power control unit configured to compare a total amount of power consumption of the electrical devices with a preset progressive amount on the basis of the analyzed result of the analyzing unit, and control supply and shutoff of power to the electrical devices on the basis of the comparison result.

2. The apparatus according to claim 1, wherein:
the analyzing unit gives a power use priority to each of the electrical devices on the basis of the power use pattern.

3. The apparatus according to claim 2, wherein:
when the total amount of power consumption of the electrical devices is equal to or greater than the progressive amount, the power control unit checks the power use priority of each of the electrical devices, and shuts off power to the electrical devices in ascending order of the power use priority.

4. The apparatus according to claim 1, wherein:
when the total amount of power consumption of the electrical devices is equal to or greater than the progressive amount, the power control unit shuts off power to an electrical device predetermined or selected by a user.

5. The apparatus according to claim 1, wherein:
the power control unit increases the number of electrical devices shut off until the total amount of power consumption of the electrical devices is less than a target value.

6. The apparatus according to claim 1, wherein:
when the total amount of power consumption of the electrical devices is less than the progressive amount, the power control unit performs control such that power to at least one electrical device is shut off according to a user set value regarding the operation of the electrical devices.

7. The apparatus according to claim 2, wherein:
when the total amount of power consumption of the electrical devices is less than a target value, the power control unit performs control such that power to electrical device having been shut off is resupplied in descending order of the power use priority.

8. The apparatus according to claim 1, wherein:
when the total amount of power consumption of the electrical devices is less than a target value, the power control unit performs control such that power is resupplied to an electrical device predetermined or selected by a user among electrical devices having been shut off.

9. The apparatus according to claim 1, wherein:
the power control unit controls ON/Oft operations of a switch, which is disposed on a power supply line connected to the at least electrical device and control power supply to the electrical device, so as to supply or shut off power to the electrical devices.

10. The apparatus according to claim 1, wherein:
the power control unit transmits a control message including a power supply or shutoff command to a corresponding electrical device such that power to the corresponding electrical device is supplied or shut off.

11. The apparatus according to claim 1, further comprising:
a storage unit configured to store environment information of the electrical devices connected to the communicating unit.

12. The apparatus according to claim 11, wherein:
the environment information of the electrical devices includes at least one of information on the relationship between the amount of power consumption of the electrical device and date/time, information on the relationship between power consumption and inside/outside temperatures, information on the operational features of the electrical devices, and information on a power use pattern of members in the home, and set information of a corresponding electrical device.

13. The apparatus according to claim 1, wherein:
the communicating unit is connected to the electrical devices through Ring or LAN.

14. A power-consumption control method for a smart meter comprising:
receiving environment information connected electrical devices;
sensing an amount of power consumption of each of the electrical devices;
analyzing the amount of power consumption of each of the electrical devices on the basis of the environment information of the electrical device in real time, and computing a power use pattern of the electrical devices; and
comparing a total amount of power consumption of the electrical devices with a preset progressive amount, and controlling supply and shutoff of power to the electrical devices on the basis of the comparison result.

15. The method according to claim 14, wherein:
the analyzing of the amount of power consumption includes giving a power use priority to each of the electrical device on the basis of the power use pattern.

16. The method according to claim 15, wherein:
when the a total amount of power consumption of the electrical devices is equal to or greater than the progressive amount, the controlling of supply and shutoff of power includes checking the power use priority of each of the electrical device and shutting off power to the electrical devices in ascending order of the power use priority.

17. The method according to claim 14, wherein:
when the a total amount of power consumption of the electrical devices is equal to or greater than the progressive amount, the controlling of supply and shutoff of power includes performing control such that power to an electrical device predetermined or selected by a user is shut off.

18. The method according to claim 14, wherein:
the controlling of supply and shutoff of power increases the number of electrical devices shut off until the total amount of power consumption of the electrical devices is less than a target value.

19. The method according to claim 14, wherein:
when the total amount of power consumption of the electrical devices is less than the progressive amount, the controlling of supply and shutoff of power includes performing control such that power to at least one electrical device is shut off according to a user set value regarding the operation of the electrical devices.

20. The method according to claim 14, wherein:
the environment information of the electrical devices includes at least one of information on the relationship between the amount of power consumption of the electrical device and date/time, information on the relationship between power consumption and inside/outside temperatures, information on the operational features of the electrical device, and information on a power use pattern of members in the home, and set information of a corresponding electrical device.
